(19) United States
(12) Patent Application Publication
(10) Pub. No.: US 2014/0366799 A1
(43) Pub. Date: Dec. 18, 2014

(54) ADHESIVE TAPE HAVING SHAPED EDGE AND METHOD OF MAKING SAME

(71) Applicant: SHURTAPE TECHNOLOGIES, LLC, Hickory, NC (US)

(72) Inventors: Brian Allan Vulpitta, Avon Lake, OH (US); Daniel Eric Festa, SR., Strongsville, OH (US); Windy Kathalikkatil, Denver, NC (US)

(73) Assignee: SHURTAPE TECHNOLOGIES, LLC, Hickory, NC (US)

(21) Appl. No.: 14/294,976

(22) Filed: Jun. 3, 2014

Related U.S. Application Data
(60) Provisional application No. 61/834,722, filed on Jun. 13, 2013.

(51) Int. Cl. B05C 21/00; B32B 43/00; B32B 37/24; B32B 37/12

(52) U.S. Cl. CPC B05C 21/005; B32B 37/12; B32B 43/006; B32B 43/003; B32B 37/24; B32B 2307/412; B32B 2307/748; B32B 2037/243; B32B 2307/726
USPC 118/505; 156/324; 156/247; 427/290

(57) ABSTRACT

An adhesive tape comprising a transparent or semi-transparent substrate having a top surface, a bottom surface, and at least one non-linear shaped masking edge, the bottom surface of the substrate having an adhesive layer applied thereto, and a liner affixed to the adhesive layer. The shaped masking edge of the adhesive layer has a treatment material applied thereto. The liner is optionally a split liner. The method for making the adhesive tape having a shaped edge comprises obtaining a tape comprised of a transparent or semi-transparent substrate having a top surface, a bottom surface, and at least one non-linear shaped edge, the bottom surface of the substrate having an adhesive layer applied thereto, and applying a liner to the adhesive layer on the bottom surface of the substrate to form a combined tape structure.

### CROSS-REFERENCE TO RELATED APPLICATIONS

This application claims priority from U.S. patent application Ser. No. 61/834,722, filed on Jun. 13, 2013, in the United States Patent and Trademark Office. The disclosure of which is incorporated herein by reference in its entirety.

### FIELD OF THE INVENTION

The present invention relates to an adhesive tape and a method of making the adhesive tape, more particularly to an adhesive tape having a shaped edge and a method of making the same.

### BACKGROUND OF THE INVENTION

Adhesive tapes for masking are typically comprised of a paper substrate having an adhesive layer applied to a bottom surface thereof In addition, some masking tapes have an upper, liquid-resistant, or liquid-proof layer applied to an upper surface of the substrate. A persistent problem with masking tapes of this type is that the tape is typically only partially successful in defining a clean masking edge or boundary between masked and unmasked surfaces. For example, when an unmasked surface is painted, it is common for paint to work its way into gaps between the adhesive layer of the tape and the surface to which the tape is applied. In addition, the paper substrate has a tendency to absorb or wick moisture from the paint through the unprotected edge of the tape substrate. This absorption causes swelling in the tape that degrades the ability of the tape to form a tight seal with the surface to which it is applied.

Another problem with existing masking tapes is that the substrate material is opaque. The masking tape is thus difficult to apply and makes it undesirable for certain purposes where aesthetics are important such as for certain design characteristics.

Yet another problem associated with masking tape and other, similar masking products is that paint that overlies the edge of the tape will cure in place and make it difficult to remove the tape from beneath the edge of the layer of cured paint. In these circumstances, tape can tear or worse, remove portions of the cured paint, thereby necessitating touch up of the painted surface.

U.S. Pat. No. 6,828,008, Gruber, incorporated by reference herein in its entirety, improves upon traditional masking tapes by applying an absorbent edge coating to at least one edge of a tape substrate. Gruber sets forth a method of applying an edge layer of absorbent material, super absorbent material in a preferred embodiment, to a roll of tape. According to Gruber, tape is typically formed in large sheets. These sheets of tape are rolled onto an elongate core to form an elongate roll of tape. The elongate roll of tape is then cut into rolls of predetermined widths. The cut sides of the rolls of tape have adhesive from the adhesive layers exposed thereon. The side or sides of each roll of tape are then pressed into a quantity of absorbent material that has been previously deposited in a container. The grains of the absorbent material are adhered to the edges of the tape by the adhesive of the adhesive layers of the tape.

However, this method is not desirable for applying an edge layer of a coating to a tape having a shaped edge (i.e. non-straight). A shaped edge presents unique challenges from a manufacturing and quality standpoint. For example, the known method discussed in Gruber is not effective in this instance due to the uneven side of the tape roll when the tape having the shaped edge is wound upon itself. In this instance, the absorbent material would be only intermittently or at best unevenly applied to the roll of tape when the side of the tape roll is pressed into the container. With a tape having an uneven edge, only the edge portion at the widest point makes contact with the two circular, parallel surfaces of the wound roll. The cut out portion of the design inside the two parallel circular planes of the wound roll would be left untreated.

Accordingly, it is an objective of the present invention to provide a method of making an adhesive tape having a shaped edge with an edge treatment.

Another objective of the present invention is to provide a method of making an adhesive tape or other masking product having a shaped edge with an edge coating material that acts as a barrier to paints or other coatings applied to a surface at a boundary between an unmasked area and a masked area of a surface.

Another objective of the present invention to provide an adhesive tape such as a painter's masking tape or other masking product that is transparent or semi-transparent, having a shaped edge. Still yet another feature of the transparent or semi-transparent masking tape is that it further comprises a half or split liner. Such a split liner provides several advantages. A split liner facilitates precise application and clean release of the adhesive tape or masking product from the surface to which it is applied. For instance, many masking tapes have the characteristic of elongation (i.e. stretch). This can cause problems with edge curling or not adhering evenly to the surface to which it is being applied. When only half of the liner is removed, the remaining liner portion on the tape wall ensures that the tape can be applied without any distortion of the tape. Furthermore, with conventional masking tapes the adhesive is exposed to the fingers of the person handling the tape during application of the tape. The split liner allows half of the tape to have the adhesive exposed and the other half of the tape to be handled and applied without touching the adhesive. Conventional masking tapes are flimsy and opaque, making it challenging to do design work. Conventional masking tapes require 100% of the tape adhesive to be applied to the surface such that adjusting the tape becomes challenging, removal adds to possible distortion of the tape, and handling the exposed edges can negatively affect the edge seal. The split liner acts as a stiffening agent, allowing only a portion of the tape to be applied making it easy to reposition on the surface. The stiffening qualities of the liner also helps minimize the tape sticking to itself.

### SUMMARY OF THE INVENTION

The present invention relates to an adhesive tape having a shaped edge and a method of making the same.

In an aspect of the invention, the adhesive tape comprises a transparent or semi-transparent substrate having a top surface, a bottom surface, and at least one non-linear shaped masking edge, the bottom surface of the substrate having an adhesive layer applied thereto, and a liner affixed to the adhesive layer. The shaped masking edge of the adhesive layer has a treatment material applied thereto.

In another aspect of the invention, the liner is optionally a split liner.

In still yet another aspect of the invention, a method is provided for making the adhesive tape comprising obtaining a tape comprised of a transparent or semi-transparent substrate having a top surface, a bottom surface, and at least one non-linear shaped edge, the bottom surface of the substrate having an adhesive layer applied thereto, and applying a liner to the adhesive layer on the bottom surface of the substrate to form a combined tape structure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a perspective view of a typical roll of prior art masking tape.

FIG. 2 is a cross-sectional view of the prior art masking tape of FIG. 1 taken along cutting lines 2-2 illustrating schematically the multiples layers thereof.

FIG. 3 is a cross-sectional view of a prior art roll of masking tape having an edge coating applied to a cut edge thereof.

FIG. 4 is a partial cross-sectional view of the prior art masking tape having an edge coating.

FIG. 5 is a perspective view of an adhesive tape having at least one shaped edge in accordance with aspects of the present invention.

FIG. 6 is a cross-sectional view of the adhesive tape of FIG. 5 taken along cutting lines A-A illustrating schematically the multiple layers thereof

FIG. 7A is an illustrative top view of an adhesive tape having a scallop-shaped tape edge design in accordance with aspects of the present invention.

FIG. 7B is an illustrative top view of an adhesive tape having a wave-shaped tape edge design in accordance with aspects of the present invention.

FIG. 7C is an illustrative top view of an adhesive tape having a chevron shaped tape edge design in accordance with aspects of the present invention.

FIG. 8 is an illustrative view of an adhesive tape having a shaped edge with a half or split liner in accordance with aspects of the present invention.

### DETAILED DESCRIPTION OF THE INVENTION

The following detailed description of the embodiment(s) is merely exemplary in nature and is in no way intended to limit the invention, its application, or uses.

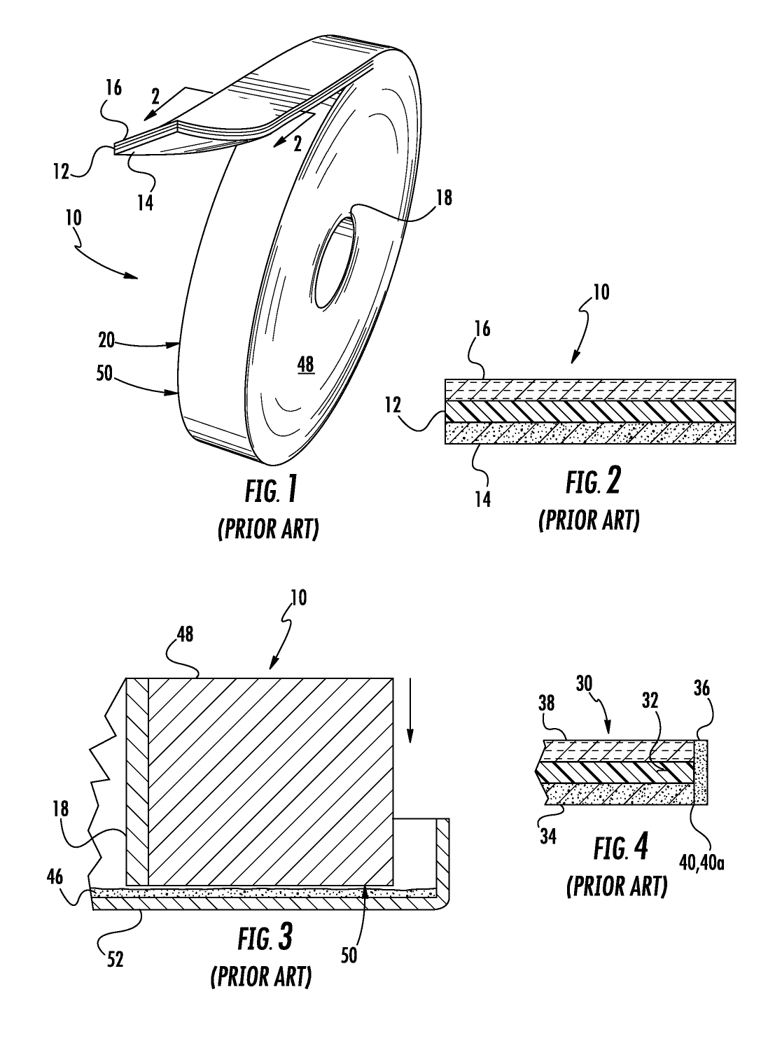

FIG. 1 is a perspective view of a typical roll of prior art masking tape. FIG. 2 illustrates a cross section of a standard, prior art adhesive tape 10 of a type commonly used for masking. Tape 10 has a middle layer or substrate 12 and an adhesive layer 14 applied to a bottom surface of the substrate 12. In some instances, tape 10 may have a top layer 16 applied to a top surface of the substrate 12 that is impervious or at least resistant to liquids. Tape 10 is most often wound on a core 18 to form a roll 20 as illustrated in FIG. 1.

FIG. 3 is a cross-sectional view of a prior art roll of masking adhesive tape 10, 30 having an edge coating applied to a cut edge thereof FIG. 3 illustrates the cut side(s) 48, 50 of tape 10, 30 having adhesive from adhesive layers 14, 34 exposed thereon. The side(s) 48, 50 of the tape are pressed into a quantity of superabsorbent material 46 that has previously been deposited in a container 52.

FIG. 4 is a partial cross-sectional view of the prior art masking tape having an edge coating. Tape 30 has a substrate 32, an adhesive layer 34, and an edge coating 36. Tape 30 may also comprise an optional liquid proof or liquid resistant top layer 38. The edge coating 36 may be applied to one or both edges of the tape 30 and may comprise any treatment material to impart desirable properties to the tape edge, e.g., absorbent material that forms a barrier to act to prevent or at least minimize the absorption of liquids into the tape substrate 32 and the ingress of liquids between the adhesive layer 34 and a surface to which the tape has been applied. An absorbent edge coating or edge layer 36 may have super-absorbent properties such that the edge coating can absorb many times its own weight in liquids brought into contact with the edge 40 of the tape 30. At the least, the edge coating 36 should have a greater absorbency than the substrate 32 of the tape 30 and tends to draw liquids from the substrate 32 and reduces or prevents the absorption of liquids into the substrate 32. The absorbency of the edge coating 36 also acts to overcome the capillary action that can draw liquids such as paint beneath the tape.

The adhesive tape of the present invention has a shaped (non-straight) edge as opposed to the tapes of FIGS. 1-4. Furthermore, the adhesive tape of the present invention may have a transparent or semi-transparent substrate which also differs from the tapes of FIGS. 1-4. The method of making the adhesive tape of the present invention also differs from the method of making the above tapes of FIGS. 1-4.

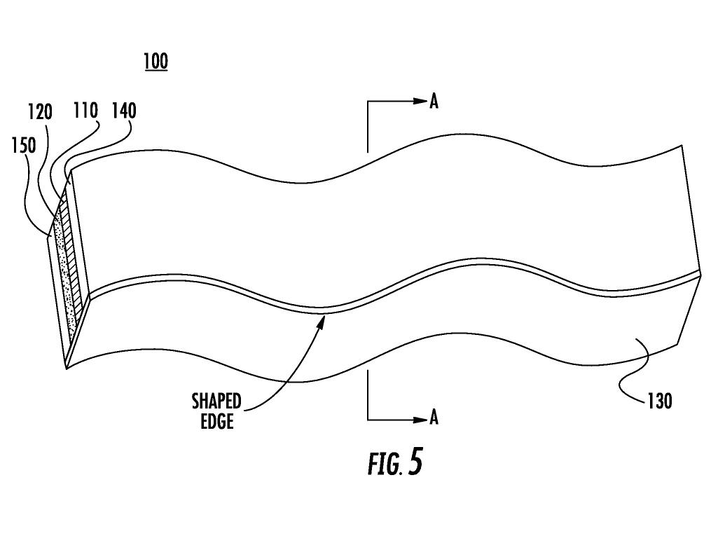

As shown generally in FIG. 5, adhesive tape 100, in accordance with aspects of the present invention, is comprised of a substrate 110, an adhesive layer 120, a an edge treatment 130, and an optional top layer 140. The substrate 110 comprises a top surface, a bottom surface, and at least one shaped masking edge. The at least one shaped masking edge is preferably non-linear. The bottom surface of the substrate 110 has adhesive layer 120 applied thereto. The substrate 110 is transparent, semi-transparent or opaque. Materials suitable for use as the tape substrate include, but are not limited to, paper and film At least one shaped masking edge has edge coating 130 applied thereto. The top surface of substrate 110 has an optional top layer applied thereto that is, for example, impervious or at least resistant to liquids. A liner 150 is affixed to the bottom of adhesive layer 120.

The adhesive of the adhesive tape may be any suitable adhesive composition, e.g. a pressure sensitive adhesive. Examples of suitable pressure sensitive adhesives include, but are not limited to, acrylics, butyl rubber, ethylene vinyl acetate, hot melt, natural rubber, nitriles, silicone rubbers, styrenic block copolymers (SBC), microsphere, synthetic rubber, and polyurethane (PU) adhesives.

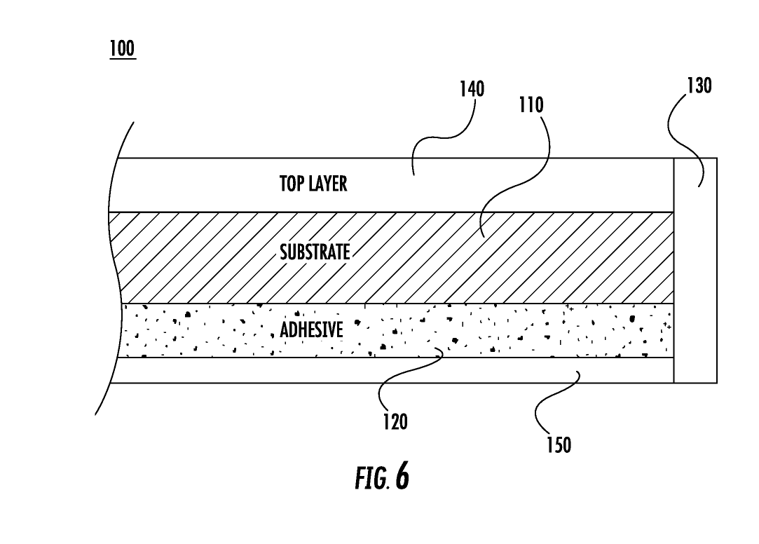

The edge coating 130 is depicted in FIG. 6 as covering each of the substrate 110, the top layer 140, the adhesive 120, and the liner 150, as the coating 130 is applied to the edge of the entire composite tape structure. However, persons skilled in the art will recognize and understand that the coating 130 may be more or less adherent to one or more layers than another, depending on the composition of the coating 130, the materials of the tape layers, and other factors. For example, it is contemplated that the edge coating 130 in certain applications and embodiments may adhere primarily to the adhesive 120. The depiction of FIG. 6 is therefore to be understood as merely representative and schematic.

According to the method of the present invention, a tape is obtained that is a (pre-slit) roll of masking tape, also referred to as painter's tape. Unlike known methods, the tape is unwound and a liner is applied to the bottom surface of the adhesive layer (i.e. the surface opposing the substrate) as a backing to form a combined tape structure. The adhesive tape and the liner are combined by any number of methods. However, preferably the adhesive tape is laminated to the liner. The liner serves at the least the purposes of keeping the adhesive tape from adhering to itself and serving as a barrier layer for the adhesive on the bottom surface of the adhesive tape. The liner is transparent, semi-transparent, or opaque.

After application of the liner, the adhesive of the tape is not exposed except for the adhesive edge or edges of the tape. The liner may extend from edge to edge of the tape or can extend beyond the edges of the tape so long as the very edges of the tape are the only exposed adhesive surfaces. After the adhesive tape and liner are combined, the combined tape is processed through a cutting device, such as a die-cutter having a pattern or design, to create a shaped (i.e. non-straight) edge to the tape. The adhesive tape and liner backing of the laminated tape are cut simultaneously in precise registry with each other. An additional cutting operation may be carried out to cut only the liner to provide a split liner feature.

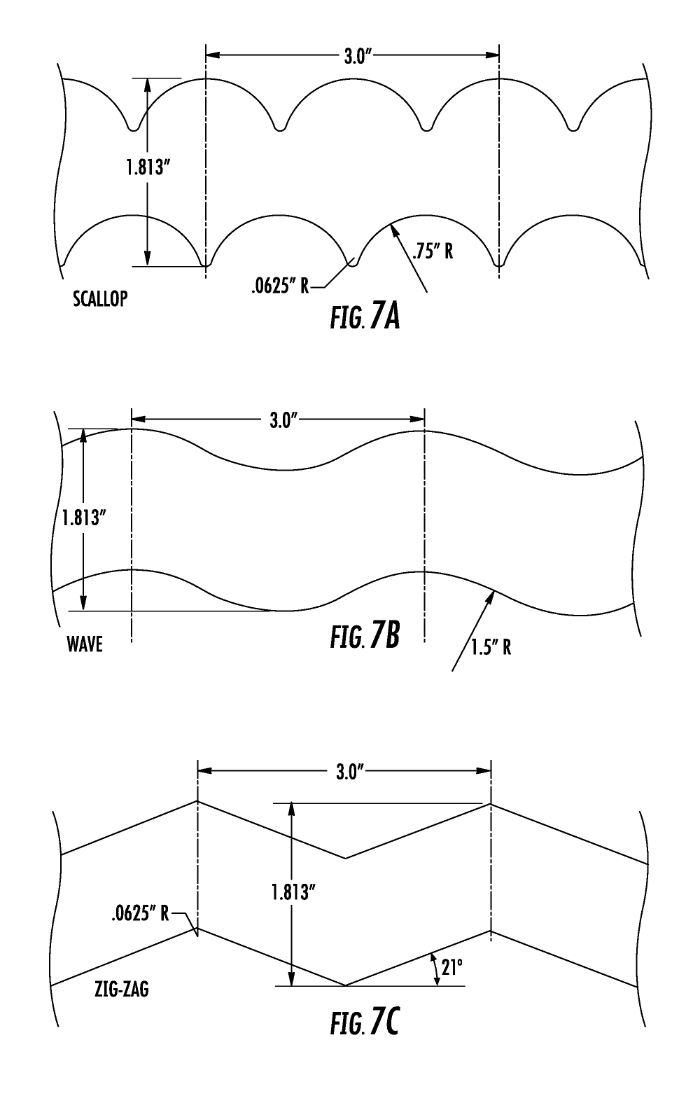

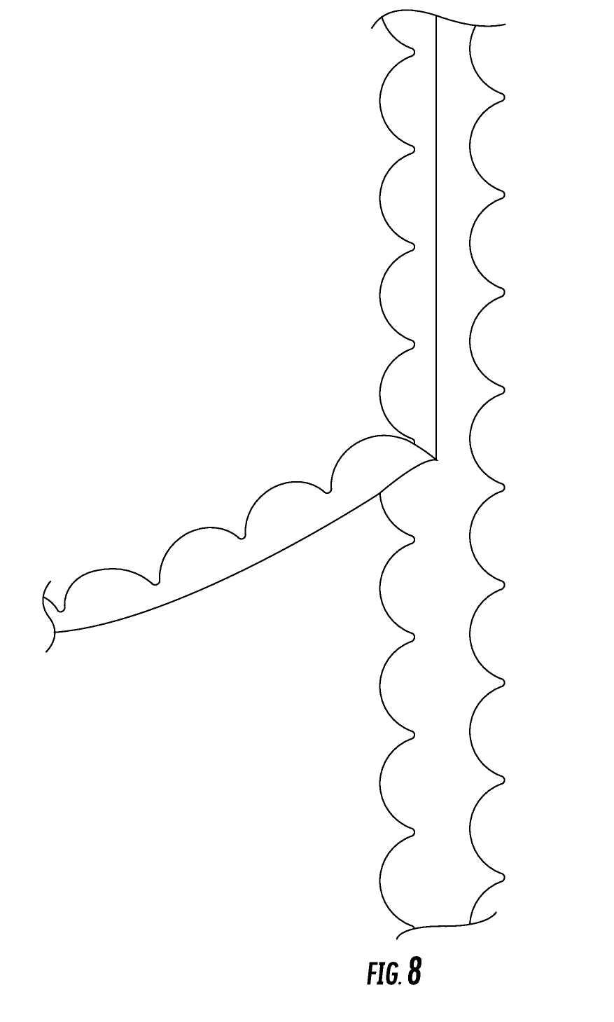

Non-limiting examples of patterns or edge designs include, but are not limited to, a wave, chevron, scallop, zig-zag, dentil, diamond, stars, moons, cutouts of any shape or design and any custom design, letters or numbers. Non-limiting examples of patterns or edge designs are shown in FIGS. 7A-7C. The dimensions shown on the patterns or edge designs in FIGS. 7A-7C are non-limiting and merely illustrative, and the patterns or edge designs may be of other dimensions and proportions. The radius also helps with taping and burnishing.

After cutting to form the shaped edge(s) of the tape, an edge treatment material is optionally applied to the shaped masking edge of the combined tape structure, e.g., as a coating on the shaped edge. The edge treatment can be applied in any conventional manner such as placement in a container, spraying, passage through a bath, printing or otherwise treating. The edge treatment takes any number of forms including, but not limited to, particulate matter, granules, gel, dispersion, and solution. In a preferred aspect of the present invention, the edge design has a radius at all transitions to help facilitate application of an edge coating material to the exposed adhesive edge of the tape.

Examples of edge coatings include, but are not limited to, lipophilic agents, flocculating agents, and a combination thereof. The lipophilic agent may be, for example, a lipophilic polymer, lipophilic resin, or lipophilic particulate. Examples of lipophilic polymers include, but are not limited to, lipophilic gels, and styrenic polymers and copolymers. More particularly, alkyl styrene polymers include crosslinked or uncrosslinked alkyl styrene polymers. Examples of lipophilic particulates include granulated lipophilic polymers such as, but not limited to, polyisobutylene, styrene-butadiene-styrene, styrene-ethylene-butadiene-styrene and styrene-isoprene-styrene copolymers. Examples of flocculating agents include, but are not limited to, calcium carbonate, talc clays, silicas, various PTFEs, silicones, aluminum chlorohydrate, multivalent salts and acidic or ionic polymers. Representative examples include inorganic flocculants (e.g. aluminum hydroxide, aluminum sulfate, ferrous sulfate, ferrous chloride, ferric sulfate, ferric hydroxide, calcium sulfate, calcium carbonate, calcium hydroxide, Fe₂(SO₄)₃FeCl₃, etc.) and organic flocculants (e.g. starch, gelatin, sodium alginate, a polyacrylamide, chitosan, etc.) as well as flocculants containing iron and aluminum or a combination thereof.

Edge coatings also include, but are not limited to, absorbent materials. A particularly preferred edge coating is known as super absorbent polymer (SAP). Super-absorbent materials are well known for their use in diapers, as soil replacements, fire retardants, and in cabling applications. Super-absorbent materials are also used in the absorption and solidification of various types of wastewaters and sludges, including radioactive waste. Super-absorbent materials are typically solid, granular cross-linked polyacrylate polymers that rapidly absorb and retain large volumes of aqueous and other types of solutions and liquids. While virtually any type of super-absorbent material may be used in conjunction with the present invention, sodium polyacrylate has proven to be particularly useful. Sodium polyacrylate is a chemical that consists of very long carbon chains that are bonded together with sodium atoms found in the center of the molecule. This structure, through osmosis, is able to absorb and retain many times its own weight. The liquids absorbed by a super-absorbent material are entirely encapsulated within the long chain molecule that makes up the super-absorbent material and these liquids are only slowly released therefrom. This slow release, coupled with the complete encapsulation of the liquids, retards the curing of liquids such as paint.

Other super-absorbent materials which may be used with the present invention include, but are not limited to, cellulosic or starch-graft copolymers and synthetic super-absorbent materials made from polyacrylic acids, polymaleic anhydride-vinyl monomers, polyvinyl alcohols, and polyacrylonitrile.

The rolls of tape may then be wound onto a core and placed in a canister or protective packaging.

In an aspect of the invention, the resulting tape can be used as is or a design(s) can be cut from the middle of the tape roll to create a stenciling effect (circles, squares, diamonds, stars, moons, etc.).

In another aspect of the invention, the adhesive tape may be a transparent or semi-transparent tape to be combined with a half or split liner in order to line-up and see the exact center of the tape as shown in FIG. 8. The half or split liner also keeps tape from stretching during application of the tape. Stretching can cause tape to peel off of a wall. The split liner adds better rigidity for purposes of handling. The use of the split liner creates a visible center line when half of the liner is removed. This provides a significant advantage to leveling and centering for tape placement and placement adjustments. A user does not touch the adhesive in application due to the presence of the split liner. The split liner thus protects the adhesive from direct user contact.

In another embodiment of the invention, a shape may be first die-cut from an adhesive tape roll or sheet and then adhered to a liner as a backing. The liner may be in the form of a sheet (such as an 8.5×11 in.) or on a roll. The liner may extend beyond the edges of the die-cut shape.

The adhesive tape of the present invention may be used in many different masking applications, including, but not limited to painting, staining, glazing, shellacking, varnishing, lacquering, cleaning, and stripping. The adhesive tape of the present invention may be used on textured and non-textured surfaces.

The present invention may be beneficially employed with adhesive tapes having polyethylene, polyester, or other synthetic substrates. These adhesive tapes may or may not further comprise a liquid-proof or liquid-resistant top layer or coating.

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A method of making an adhesive tape, the method comprising:
obtaining a tape comprised of a transparent or semi-transparent substrate having a top surface, a bottom surface, and at least one non-linear shaped edge, the bottom surface of the substrate having an adhesive layer applied thereto, and
applying a liner to the adhesive layer on the bottom surface of the substrate to form a combined tape structure.

2. The method of making according to claim 1, wherein the tape is a masking tape.

3. The method of making according to claim 1, wherein the shaped edge has a masking edge.

4. The method according to claim 1, further comprising applying a treatment material to the at least one non-linear shaped edge of the tape substrate.

5. The method according to claim 4, wherein the treatment material is applied to the adhesive layer at the at least one non-linear shaped edge of the tape substrate.

6. The method according to claim 4, wherein the treatment material is in a form of particulate matter, granules, gel, dispersion, coating or solution.

7. The method according to claim 4, wherein the treatment material is a lipophilic agent, flocculating agent, or a combination thereof.

8. The method according to claim 7, wherein the lipophilic agent is a lipophilic polymer, lipophilic resin, or lipophilic particulate.

9. The method according to claim 7, wherein the flocculating agent is a calcium carbonate, talc clay, silica, PTFE, silicone, aluminum chlorohydrate, multivalent salt, an acidic polymer, or an ionic polymer.

10. The method according to claim 7, wherein the flocculating agent is inorganic, organic, or contains iron and aluminum or a combination thereof.

11. The method according to claim 4, wherein the treatment material is an absorbent material.

12. The method according to claim 11, wherein the absorbent material is a super absorbent polymer (SAP).

13. The method according to claim 1, wherein the adhesive is a pressure sensitive adhesive.

14. The method according to claim 13, wherein the pressure sensitive adhesive is acrylic, butyl rubber, ethylene vinyl acetate, hot melt, natural rubber, nitrile, silicone rubber, styrenic block copolymer (SBC), microsphere, synthetic rubber, polyurethane (PU) adhesive, or a combination thereof.

15. The method according to claim 1, wherein application of the liner to the adhesive tape is by lamination.

16. The method according to claim 1, wherein the liner is transparent, semi-transparent, or opaque.

17. The method according to claim 1, wherein the liner covers a majority of the adhesive.

18. The method according to claim 1, further comprising treating the combined tape structure with a treatment material.

19. The method according to claim 18, wherein only the adhesive comes in direct contact with treatment material.

20. The method according to claim 18, further comprising removing the liner.

21. The method according to claim 1, wherein the shaped edge is in a shape of a wave, chevron, scallop, zig-zag, dentil, diamond, star, moon, letter or number.

22. The method according to claim 1, wherein the liner is a split liner.

23. The method according to claim 22, further comprising creating a visible center line by removal of a half of the split liner.

24. A method of making an adhesive tape for masking, the method comprising:
obtaining a tape for masking comprised of a transparent or semi-transparent substrate having a top surface, a bottom surface, and an adhesive layer applied to the bottom surface,
cutting the tape to form at least one non-linear shaped masking edge of the tape, and
applying an edge treatment material to the at least one non-linear shaped masking edge of the tape.

25. An adhesive tape comprising:
a transparent or semi-transparent substrate having a top surface, a bottom surface, and at least one non-linear shaped masking edge, the bottom surface of the substrate having an adhesive layer applied thereto, and
a liner affixed to the adhesive layer.

26. The adhesive tape according to claim 25, wherein the adhesive tape is a masking tape.

27. The adhesive tape according to claim 25, wherein the shaped edge has a masking edge.

28. The adhesive tape according to claim 25, wherein at least one non-linear shaped masking edge of the tape substrate comprises a treatment material.

29. The adhesive tape according to claim 28, wherein the treatment material is applied to the adhesive layer at the at least one non-linear shaped masking edge of the tape substrate.

30. The adhesive tape according to claim 28, wherein the treatment material is in a form of particulate matter, granules, gel, dispersion, coating or solution.

31. The adhesive tape according to claim 28, wherein the treatment material is a lipophilic agent, flocculating agent, or a combination thereof

32. The adhesive tape according to claim 31, wherein the lipophilic agent is a lipophilic polymer, lipophilic resin, or lipophilic particulate.

33. The adhesive tape according to claim 31, wherein the flocculating agent is a calcium carbonate, talc clay, silica, PTFE, silicone, aluminum chlorohydrate, multivalent salt, an acidic polymer, or an ionic polymer.

34. The adhesive tape according to claim 31, wherein the flocculating agent is inorganic, organic, or contains iron and aluminum or a combination thereof.

35. The adhesive tape according to claim 28, wherein the treatment material is an absorbent material.

36. The adhesive tape according to claim 35, wherein the absorbent material is a super absorbent polymer (SAP).

37. The adhesive tape according to claim 25, wherein the adhesive is a pressure sensitive adhesive.

38. The adhesive tape according to claim 36, wherein the pressure sensitive adhesive is acrylic, butyl rubber, ethylene vinyl acetate, hot melt, natural rubber, nitrile, silicone rubber, styrenic block copolymer (SBC), microsphere, synthetic rubber, polyurethane (PU) adhesive, or a combination thereof.

39. The adhesive tape according to claim 25, wherein the liner is transparent, semi-transparent, or opaque.

40. The adhesive tape according to claim 25, wherein the liner covers a majority of the adhesive.

41. The adhesive tape according to claim 25, wherein only the adhesive is treated with the treatment material.

42. The adhesive tape according to claim 25, wherein the shaped edge is in a shape of a wave, chevron, scallop, zig-zag, dentil, diamond, star, moon, letter or number.

43. The adhesive tape according to claim 25, wherein the liner is a split liner.

44. The adhesive tape according to claim 43, wherein a visible center line is formed by removal of a half of the split liner.

45. An adhesive tape comprising:
a transparent or semi-transparent substrate having a top surface, a bottom surface, and at least one non-linear shaped masking edge, the bottom surface of the substrate having an adhesive layer applied thereto, and
a treatment material applied to at least one non-linear shaped masking edge of the tape substrate.
